(19) United States
(12) Patent Application Publication
(10) Pub. No.: US 2014/0060750 A1
(43) Pub. Date: Mar. 6, 2014

(54) PEELING APPARATUS

(71) Applicants: HONG FU JIN PRECISION INDUSTRY (ShenZhen) CO., LTD., (US); HON HAI PRECISION INDUSTRY CO., LTD., New Taipei (TW)

(72) Inventors: ZHAO-YONG LI, Shenzhen (CN); LIAN-GANG XUE, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/863,419

(22) Filed: Apr. 16, 2013

(30) Foreign Application Priority Data
Aug. 31, 2012 (CN) 201210317637.4

(51) Int. Cl. B65C 9/42

(52) U.S. Cl. CPC B65C 9/42
USPC 156/751

(57) ABSTRACT

A peeling apparatus for peeling labels in rows from a tape-shaped release paper comprises a main body, a peeling mechanism, a driving mechanism and a sensing mechanism. The peeling mechanism locates the release paper and peels the labels in a row from the release paper when being rotating. The sensing mechanism located upon the peeling mechanism and parallel with the peeling mechanism. The labels in a row are orderly arranged from a first position to a second position on the release paper. The sensing mechanism comprises at least two detectors which are perpendicular to the peeling mechanism. When the peeled labels facing the sensing mechanism, either of the at least two detectors detects the peeled labels at the first position or the second position to generate a pause signal. The driving mechanism stops driving the peeling mechanism rotating in response to the pause signal.

### BACKGROUND

1. Technical Field

The present disclosure relates to peeling apparatuses, particular relates to a peeling apparatus for peeling labels from a release paper.

2. Description of Related Art

Peeling apparatuses peel labels from a tape-shaped release paper. The labels are pasted on the release paper in rows. The peeling apparatus includes a peeling mechanism, a driving mechanism, and a detector. The peeling mechanism synchronously peels the labels in a row from the release paper when being rotated by the driving mechanism. Each of the labels is partly peeled from the release paper. The detector is parallel and staggered with the peeling mechanism. The detecting range of the detector is equal to the size of one label. When the peeled label directly facing the detector is being detected, the detector generates a pause signal. The driving mechanism stops driving the peeling mechanism rotating in response to the pause signal. However, in operation, an operator needs to manually keep the label facing the detector while being taken off labels from the release paper, it will easily cause misoperation.

Therefore, there is room for improvement in the art.

### BRIEF DESCRIPTION OF THE FIGURE

The components of the drawings are not necessarily drawn to scale, the emphasis instead being placed upon clearly illustrating the principles of the embodiment of a peeling apparatus. Moreover, in the drawings, like reference numerals designate corresponding parts throughout several views.

FIG. 1 is a schematic view of a peeling apparatus, according to an embodiment.

FIG. 2 shows another view of the peeling apparatus of FIG. 1.

FIG. 3 is partially disassembled view of the peeling apparatus of FIG. 1.

FIG. 4 shows another view of the peeling apparatus of FIG. 1.

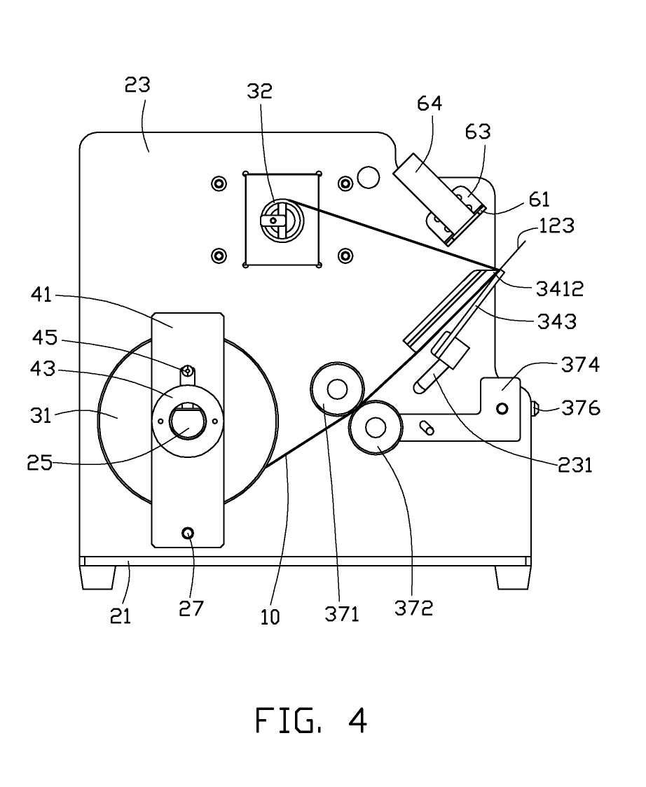

### DETAILED DESCRIPTION

Embodiments of the present disclosure will be described in detail with reference to the drawings.

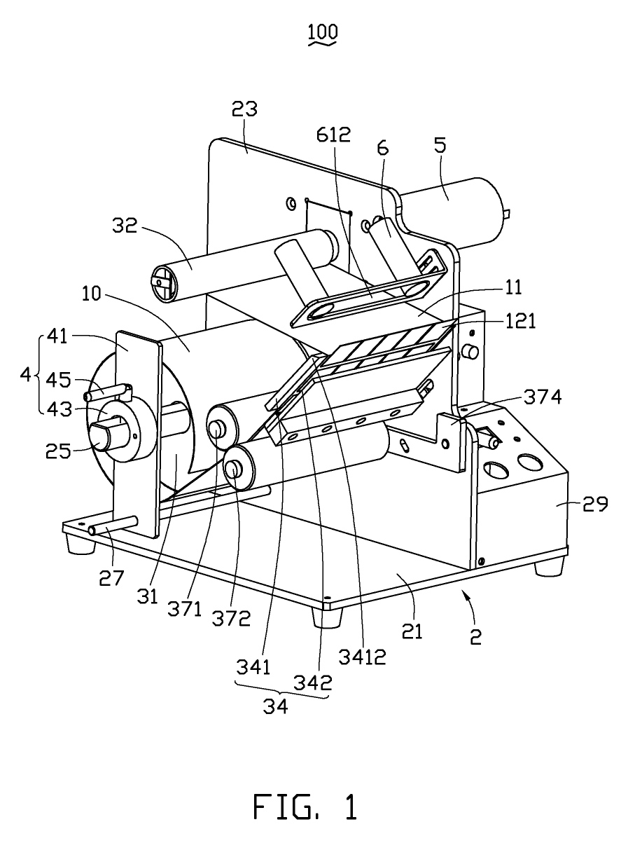

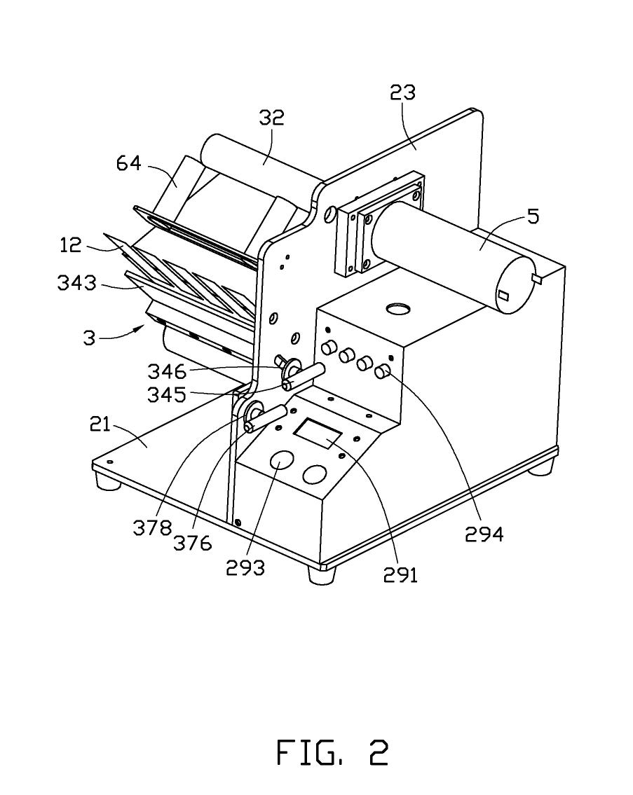

FIGS. 1 and 2 show a peeling apparatus 100 of the embodiment. The peeling apparatus 100 is used for peeling labels 12 in rows from a tape-shaped release paper 11. The release paper 11 includes a free end (not labeled) without label 12. The labels 12 are spaced from each other on the release paper 11, and arranged in order from a first position to a second position. Each of the labels 12 includes an information surface 121 and an adhesive surface 123 opposite to the information surface 121. The information surface 121 is printed with various kinds of information. The adhesive surface 123 is used for detachably pasting the label 12 on the release paper 11. In the embodiment, each four labels 12 pasted on the release paper 11 are in a row and parallel with each other.

The peeling apparatus 100 includes a main body 2, a peeling mechanism 3, a fixing mechanism 4, a driving mechanism 5, and a sensing mechanism 6. The peeling mechanism 3, fixing mechanism 4, a driving mechanism 5, and the sensing mechanism 6 are mounted on the main body 1.

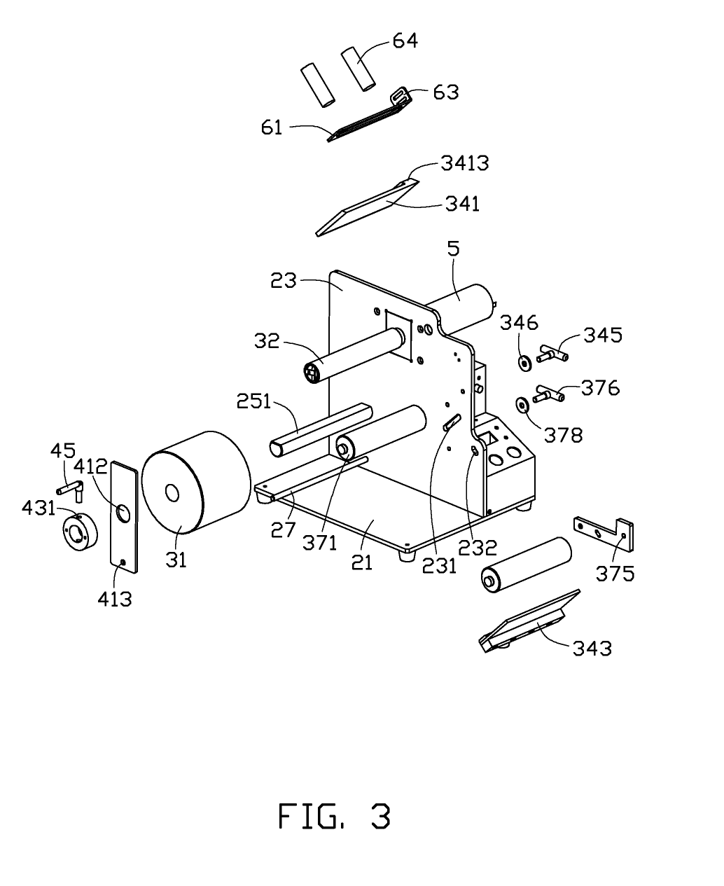

FIG. 3 shows that the main body 2 of the embodiment includes a base 21, a wall 23, a first cantilever 25, a second cantilever 27, and a control portion 29. The base 21 is substantially rectangular. The wall 23 is perpendicularly mounted on the middle of the base 21. The wall 23 defines a first sliding slot 231 and a second sliding slot 232, which are adjacent to an edge of the wall 23 perpendicular to the base 21. The first sliding slot 231 forms a predetermined angle with the base 21. Two opposite ends of the first sliding slot 231 are substantially arcuate. The second sliding slot 232 is perpendicular to and spaced from the first sliding slot 231. Two opposite ends of the second sliding slot 232 are substantially arcuate. The distance between the first sliding slot 231 and the base 21 is larger than that between the second sliding slot 232 and the base 21. The distance between the first sliding slot 231 and the edge of the wall 23 is larger than that between the second sliding slot 232 and the edge of the wall 23. The length of the second sliding slot 231 is shorter than that of the first sliding slot 231. The first cantilever 25 and the second cantilever 27 are perpendicularly secured on a surface of the wall 23 on another edge of the wall 23 opposite to the edge defining the first sliding slot 231 and the second sliding slot 232. The first cantilever 25 and the second cantilever 27 are parallel with each other and arranged in a line perpendicular to the base 21. The first cantilever 25 is away from the base 21. The cross section of the first cantilever 25 is substantially D-shaped. The first cantilever 25 includes a first surface 251. The first surface 251 is parallel with and opposite to the base 21. The second cantilever 27 adjacent to the base 21 is substantially cylindrical. The diameter of the second cantilever 27 is less than that of the first cantilever 25.

The control portion 29 is perpendicularly secured on the base 21 and against the wall 23 but on the opposite surface where the first cantilever 25 and the second cantilever 27 are secured. The control portion 29 is used for controlling the driving mechanism 5. The control portion 29 includes a display member 291, two control buttons 293, and a plurality of adjusting buttons 294. The display member 291 formed an angle with the base 21 is used for displaying the total number of the labels 12 peeled by the peeling apparatus 100. The control buttons 293 below the display member 291 are arranged in a line parallel with the base 21. The control buttons 293 are coplanar with display member 291. The two control buttons 293 respectively generate a start signal and a stop signal to the driving mechanism 3 when being pressed. The adjusting buttons 294 above the display member 291 are arranged in a line parallel with the base 21. The adjusting buttons 294 are used for adjusting the rotating speed of the driving mechanism 5. Each of the adjusting buttons 294 corresponds to a different rotating speed when being pressed. In the other embodiments, the control portion 29 may include only one adjusting button 294 which can be rotated to adjust the rotating speed of the driving mechanism 5.

The peeling mechanism 3 is perpendicularly secured on the surface of the wall 23 where the first cantilever 25 and the second cantilever 27 are secured. The peeling mechanism 3 includes a first roller 31, a second roller 32, a peeling member 34 (as shown in FIG. 1), and a positioning member 37. The position of the first roller 31, the second roller 32, and the peeling member 34 on the wall 23 form a triangle. The first roller 31 is rotatably sleeved on the first cantilever 25. The first roller 31 is substantially cylindrical and used for locating the release paper 11 pasted with the labels 12. The second roller 32 is arranged in the oblique upward direction from the first roller 31. The second roller 32 is substantially cylindrical and used for collecting the release paper 11 without the labels 12. The second roller 32 defines a sliding slit (not shown) along the axis of the second roller 32.

The peeling member 34 includes a resisting portion 341, and a pressing portion 342. The resisting portion 341 is substantially a flat rectangular plate. The resisting portion 341 is located above the first sliding slot 231 and parallel with the first sliding slot 231. The resisting portion 341 includes a first end 3412 away from the base 21 and a guide portion 3413. The first end 3412 is substantially cuniform. The guide portion 3413 perpendicularly extends from the edge of the resisting portion 341 adjacent to the wall 23. The pressing portion 342 is perpendicularly secured on the wall 23 and angled with the base 21. The pressing portion 342 is capable of sliding in the first sliding slot 231 to adjust the position of the pressing portion 342. The pressing portion 342 includes a plate 343, a first rotating portion 345, and a first limiting portion 346. The plate 343 is substantially rectangular and parallel with the resisting portion 341. An angle can be formed between the restating portion 341 and the plate 343 via rotating the first rotating portion 345. The first rotating portion 345 is above the control portion 29 and fixed on the plate 343 through the first sliding slot 231 and the first limiting portion 346. The first rotating portion 345 is used for adjusting the angle between the resisting portion 341 and the plate 343. The first rotating portion 345 is substantially T-shaped. The first limiting portion 346 is substantially annular shaped. The first limiting portion 346 is used for preventing the first rotating portion 345 from falling out of the first sliding slot 231.

The positioning portion 37 between first roller 31 and the peeling member 34 includes a first retaining roller 371, a second retaining roller 372, a locating portion 374, a second rotating portion 375, and a second limiting portion 378. The first retaining roller 371 is perpendicularly secured on the wall 23 and parallel with the second retaining roller 372. The first retaining roller 371 is away from the base 21 and is substantially cylindrical. The first retaining roller 371 is capable of rotating about the longitudinal axis of the first retaining roller 371. The second retaining roller 372 is adjacent to the base 21 and secured on the locating portion 374. The second retaining roller 372 is substantially cylindrical and capable of rotating about the longitudinal axis of the second retaining roller 372. The locating portion 374 is substantially L-shaped and used for adjusting the distance between the first retaining roller 371 and the second retaining roller 372. An end of the locating portion 374 facing the second sliding slot 232 defines a fixing hole 375. The second rotating portion 376 is screwed with the fixing hole 375 through the second sliding slot 232 and the second limiting portion 378. The second rotating portion 376 is substantially T-shaped. The second limiting portion 378 is substantially annular shaped. The second limiting portion 378 is capable of preventing the second rotating portion 376 from falling out of the second sliding slot 232.

The fixing mechanism 4 is sleeved on the first cantilever 25 and the second cantilever 27. The fixing mechanism 4 is used for preventing the first roller 31 and the release paper 11 pasted with the labels 12 from falling out of the first cantilever 25. The fixing mechanism 4 includes a blocking portion 41, a locking portion 43, and a positioning pin 45. The blocking portion 41 is sleeved on the first cantilever 25 and the second cantilever 27. The blocking portion 41 is substantially a flat rectangular plate. The blocking portion 41 defines a first pivot hole 412 and a second pivot hole 413. The first pivot hole 412 corresponds to the first cantilever 25 and the second pivot hole 413 corresponds to the second cantilever 27. The axis of the first pivot hole 412 and the axis of the second pivot hole 413 are arranged in a line. The diameter of the first pivot hole 412 is larger than that of the second pivot hole 413. The locking portion 43 defines a through hole 431 along the diameter direction of the locking portion 43. The locking portion 43 is substantially annular shaped. The positioning pin 45 connects with the first surface 251 via the through hole 431 for preventing the locking portion 43 from rotating. The positioning pin 45 is substantially L-shaped.

The driving mechanism 5 is perpendicularly mounted on the second roller 32 through the wall 23 and above the control portion 29. The driving mechanism 5 is used for driving the second roller 32 to rotate in response to the start signal and stop driving the second roller 32 in response to the stop signal.

The sensing mechanism 6 is located above the resisting portion 341 and parallel with the resisting portion 341. The sensing mechanism 6 includes a placing portion 61, a fixing portion 63, and two detectors 64. The placing portion 61 is parallel and staggers with resisting portion 341. The placing portion 61 is used for mounting the detectors 64 and defines an opening 612. The placing portion 61 is substantially rectangular. The length of the opening 612 is equal to the length of the first end 3412. The fixing portion 63 is perpendicular to an end of the placing portion 61 adjacent to the wall 23. The fixing portion 63 is substantially rectangular and used for fixing the placing portion 61 on the wall 23. One end of the two detectors 64 are blocked in the opening 612 and respectively located at two opposite ends of the opening 612. The detectors 64 are capable of sliding in the opening 612 for keeping the two detectors 64 respectively perpendicular to the first position and the second position. The detecting range of each of the detectors 64 only is equal to the size of one peeled label 12. When the peeled label 12 directly facing the detector 64 is being detected, the detector 64 generates a pause signal. The detectors 64 are substantially cylindrical. In the embodiment, the detectors 64 are infrared sensors. In other embodiments, the sensing mechanism 6 can include more than two detectors 64.

In assembly, the release paper 11 with the labels 12 is sleeved on the first roller 31. The first roller 31 is sleeved on the first cantilever 25. The blocking portion 41 and the locking portion 43 are orderly sleeved on the first cantilever 25. The positioning pin 45 is inserted into the through hole 431 and connected with the first surface 251. The blocking portion 41 is further sleeved on the second cantilever 27. Therefore, the first roller 31 is blocked between the wall 23 and the blocking portion 41. The free end of the release paper 11 is passed through the space between the first retaining roller 371 and the second retaining roller 372, and further passed through the space between the resisting portion 341 and the plate 343, and is fixed in the second roller 32 through the sliding slit. By sliding the locating portion 374 in the second slot 232, the release paper 11 is tightly sandwiched between the first retaining roller 371 and the second retaining roller 372. By rotating the plate 343, the release paper 11 is tightly sandwiched between the first end 3412 and the plate 343. When the operator presses the control button 293 for generating a start signal, the driving mechanism 5 drives the second roller 32 to rotate. The release paper 11 with the labels sleeved on the first roller 31 is driven along a first direction from the first roller 31 to the first end 3412 by the rotating second roller 32, and the first roller 31 starts to rotate by the moving release paper 11. The rotating direction of the first roller 31 is the same as that of the second roller 32. In the embodiment, the first roller 31 and the second roller 32 synchronously rotates in a counterclockwise direction. In other embodiments, the first roller 31 and the second roller 32 can synchronously rotate in a clockwise direction. When arriving at the first end 3412, the release paper 11 moves along a second direction from the first end 3412 to the second roller 32 which forms an acute angle with the first direction. The labels 12 in a row still are all moving along the first direction for peeling from the release paper 11. When the peeled label 12 at the first position or the second position facing the corresponding detector 64, the detector 64 generates the pause signal. The control mechanism 29 controls the driving mechanism 5 to stop rotating. The adhesive surface 121 of the label 12 is upward.

As described, the operator can orderly take off the labels 12 in a row along either directions perpendicular to the wall 23. The information surface of the label 12 is in an inversion state and is consistent with a production where the label 12 to be pasted on. Therefore, the taking operation is improved.

While various exemplary and preferred embodiments have been described, the disclosure is not limited thereto. On the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A peeling apparatus for peeling labels in rows from a tape-shaped release paper, the peeling apparatus comprising:
a main body;
a peeling mechanism configured to locate the release paper and peel one row of the labels from the release paper at a time when being rotating;
a driving mechanism configured to drive the peeling mechanism to rotate; and
a sensing mechanism located upon the peeling mechanism and parallel with the peeling mechanism;
wherein the labels in a row are orderly arranged from a first position to a second position on the release paper; the sensing mechanism comprises at least two detectors which are perpendicular to the peeling mechanism; when the peeled labels facing the sensing mechanism, either of the at least two detectors detects the peeled labels at the first position or the second position to generate a pause signal, the driving mechanism stops driving the peeling mechanism rotating in response to the pause signal.

2. The peeling apparatus of claim 1, wherein the position of the at least two detectors are adjustable.

3. The peeling apparatus of claim 2, wherein the main body comprises a first cantilever; the peeling mechanism comprises a first roller, a second roller above the first roller, and a peeling member; the first roller sleeved on the first cantilever secures the release paper with labels; when being rotating by the driving mechanism, the release paper moves along a first direction from the first roller to the peeling member and turns to move along a second direction from the peeling member to the second roller, the first direction forms an angle with the second direction; each of the peeled label is partly peeled at the peeling member.

4. The peeling apparatus of claim 3, wherein the label comprises an information surface and an adhesive surface opposite to the information surface; the labels are pasted on the release paper through the adhesive surface; the adhesive surface of the peeled label is upward.

5. The peeling apparatus of claim 3, wherein the first roller, the second roller, and the peeling member form a triangle; the second roller and the peeling member are located on the oblique upward direction from the first roller.

6. The peeling apparatus of claim 3, wherein the main body comprises a base and a wall perpendicular to the base; the peeling mechanism and the driving mechanism are perpendicularly secured on opposite surfaces of the wall; the first cantilever parallel with the base is perpendicularly secured on the surface of the wall where the peeling mechanism is secured.

7. The peeling apparatus of claim 6, wherein the peeling member comprises a resisting portion and a pressing portion parallel with the resisting portion; the pressing portion is adjustable to form an angle with the resisting portion; when the release paper with labels passes through the space between the resisting portion and the pressing portion, by adjusting the pressing portion to resist an end of the resisting portion, the release paper is tightly sandwiched between the resisting portion and the pressing portion.

8. The peeling apparatus of claim 7, wherein the sensing mechanism comprises a placing portion parallel with the resisting portion, and a fixing portion; the placing portion above the resisting portion is perpendicular to the wall; the placing portion defines an opening; the fixing portion is perpendicular to an end of the placing portion adjacent to the wall and used for fixing the placing portion on the wall; the two detectors are blocked in the opening and capable of sliding in the opening.

9. The peeling apparatus of claim 7, wherein the resisting portion comprises a first end away from the base and a guide portion; the first end away from the base cooperates with the pressing portion to peel the labels from the release paper; the guide portion perpendicularly extends from an edge of the resisting portion adjacent to the wall.

10. The peeling apparatus of claim 7, wherein the wall defines a first sliding slot angled with the base; the peeling member further comprises a first rotating portion; the pressing portion is corresponding to the first sliding slot, and the resisting portion is above the pressing portion; the first rotating portion is fixed on the pressing portion through the first sliding slot and used for adjusting the angle between the resisting portion and the pressing portion.

11. The peeling apparatus of claim 10, wherein the first rotating portion is substantially T-shaped.

12. The peeling apparatus of claim 7, wherein the peeling member further comprises a positioning portion between the first roller and the peeling member; the positioning portion comprises a first retaining roller secured on the wall and a second retaining roller parallel with the first retaining roller; the first retaining roller and the second retaining roller are arranged in a line which forms an angle with the base; the release paper is passed through the space between the first retaining roller and the second retaining roller and being tightly sandwiched.

13. The peeling apparatus of claim 10, wherein the wall further defines a second sliding slot; the positioning portion further comprises a locating portion and a second rotating portion; the second retaining roller is secured on the locating portion; the locating portion is screwed with the second rotating portion via the second sliding slot; the locating portion is capable of sliding along the second sliding slot to adjust the distance between the first retaining roller and the second retaining roller.

14. The peeling apparatus of claim 1, wherein the peeling apparatus further comprises a control mechanism below the driving mechanism; the control mechanism comprises two control buttons; the control buttons respectively generates a start signal and a stop signal when being pressed; the driving mechanism starts rotating in response to the start signal and stop rotating in response to the stop signal.

15. The peeling apparatus of claim 14, wherein the control mechanism further comprises a display member; the display member is located above the two control buttons; the display member angled with the base is used for displaying the total number of the peeled labels.

16. The peeling apparatus of claim 14, wherein the control mechanism further comprises a plurality of adjusting buttons; the adjusting buttons are arranged in a line parallel with the base; each of the adjusting buttons corresponds to a different rotating speed.

17. The peeling apparatus of claim 2, wherein the main body further comprises a second cantilever; the positioning portion further comprises a fix mechanism for preventing the first roller from falling off the first cantilever; the fixing mechanism comprises a blocking portion, a locking portion, and a positioning pin; the blocking portion defines a first pivot hole and second pivot hole; the locking portion defines a through hole; the blocking portion is sleeved on the first cantilever and the second cantilever through the first pivot hole and the second pivot hole; the locking portion is sleeved on the first cantilever and resists the blocking portion; the positioning pin is inserted into the through hole and resists the first cantilever.

18. The peeling apparatus of claim 17, wherein the second cantilever is located below the first cantilever; the first cantilever and the second cantilever are parallel with each other and arranged in a line perpendicular to the base.

19. The peeling apparatus of claim 1, wherein the detectors are infrared sensors.
